(19) United States
(12) Patent Application Publication
(10) Pub. No.: US 2017/0276774 A1
(43) Pub. Date: Sep. 28, 2017

(54) METHOD AND DEVICE FOR BOOSTING LOW-FREQUENCIES FOR A MARINE SEISMIC SURVEY

(71) Applicant: CGG SERVICES SAS, Massy Cedex (FR)

(72) Inventors: Yuan NI, Paris (FR); Honglei SHEN, Olso (NO); Thomas ELBOTH, Olso (NO)

(73) Assignee: CGG SERVICES SAS

(21) Appl. No.: 15/516,557

(22) PCT Filed: Oct. 6, 2015
(86) PCT No.: PCT/IB2015/002147

§ 371 Date: Apr. 3, 2017

Related U.S. Application Data
(60) Provisional application No. 62/080,461, filed on Nov. 17, 2014.
(60) Provisional application No. 62/075,040, filed on Nov. 4, 2014.
(60) Provisional application No. 62/060,631, filed on Oct. 7, 2014.

(51) Int. Cl. G01S 7/52; G10K 11/00; G01S 15/89; G01S 7/487; G01S 15/87

(52) U.S. Cl. CPC G01S 7/52003; G01S 7/4876; G01S 15/878; G01S 15/8902; G10K 11/008; G01V 1/201

(57) ABSTRACT

Systems and methods for boosting low content of received signals involve a vessel (102) towing port side (205) and starboard side (210) impulsive source arrays. The port side and starboard side impulsive source arrays are selectively actuated for a plurality of sequential shots having different signatures.

### CROSS REFERENCE TO RELATED APPLICATIONS

This application claims priority and benefit from U.S. Provisional Patent Application No. 62/060,631, filed on Oct. 7, 2014, for “System for Improving the Super Low Frequencies of a Marine Seismic Source,” U.S. Provisional Patent Application No. 62/075,040, filed on Nov. 4, 2014, for “Use De-Synchronized Air-Gun for Low-Frequency Boost,” and U.S. Provisional Patent Application No. 62/080,461, filed on Nov. 17, 2014, for “Use De-Synchronized Air-Gun for Low-Frequency Boost,” the entire content of these application is incorporated in their entirety herein by reference.

### BACKGROUND

Technical Field

Embodiments of the subject matter disclosed herein generally relate to methods and systems for marine seismic surveys. More specifically, the embodiments relate to improving the low frequency response of marine seismic surveys.

Discussion of the Background

Marine seismic data acquisition and processing generate a profile (image) of the geophysical structure (subsurface) under the seafloor by using a marine seismic survey system that fires a source toward the geophysical structure and collects reflections from the geophysical structure. FIG. 1 illustrates an example of a marine seismic survey system 100, which includes a vessel 102 towing a number of seismic sensors 104 distributed along at least one streamer 106. The streamers may be disposed horizontally, i.e., lying at a constant depth z₁ relative to the ocean surface 110.

Each streamer may have a head float 106a and a tail float 106b connected to respective streamer ends for maintaining the given depth z₁. Lead-in 112 includes various cables connecting streamers 106 to vessel 102. Vessel 102 also tows a source 120 configured to generate an acoustic wave 122a. As illustrated in FIG. 2, a source typically includes a port side array 205 and starboard side array 210. Each of the arrays 205 and 210 include a number of sub-arrays, which in FIG. 2 includes 3 sub-arrays. Each sub-array is a tuned string with different gun volumes, which are mainly used to cancel bubbles. In FIG. 2 the volumes of the guns of the starboard side sub-arrays is illustrated and for sake of simplicity the volumes of the guns of the corresponding port side sub-arrays are not.

A survey typically involves actuation of either the port or starboard side array for a single shot and then after a sufficient time for collection of the reflected signals, the other of the port and starboard side arrays is actuated for a subsequent collection of reflected signals. An example of this is illustrated in FIG. 3, where a first shot 305 involves actuation of the port side source array 310, and after an inter-shot delay 315, which is typically 10 seconds, a second shot 320 is performed, which involves actuation of a starboard side source array 325. This sequence is then repeated a number of times during the survey.

Returning to FIG. 1, actuation of source 120 generates an acoustic wave 122a propagating downward toward the seafloor 124 and acoustic wave 123a propagating upward towards the water surface 110. Acoustic wave 122a penetrates the seafloor 124 and is eventually reflected by a reflecting structure 126 (reflector) so that a reflected acoustic wave 122b propagates upward and is received by seismic sensor 104. Since the interface between the water and air is well approximated as a quasi-perfect reflector (i.e., the water surface acts as a mirror for the acoustic waves), upward traveling acoustic wave 123a is initially reflected by water surface 110. Reflected acoustic wave 123b propagates towards and penetrates the seafloor 124, and then is reflected by a reflecting structure 126 so that a reflected acoustic wave 123c propagates upward and is received by seismic sensor 104.

The acoustic wave 123c received by seismic sensor 104 is a ghost signal having a reverse polarity and time lag relative to the primary wave 122b. The ghost signal affects the spectrum of the signal reflected from the subsurface and causes notches at certain frequencies fₙ (vertical direction).

$${f}_{n} = \frac{nc}{2 h} ( n = 0 , 1 , 2 … ) , \qquad ( 1 )$$

where c is the speed of sound and h is the depth for the horizontal source. The ghost signal also boosts other frequencies. The frequency notches and boosts caused by the ghost signal have a negative impact on the ability to depict the subsurface by causing gaps in the frequency content recorded by the seismic sensors, which reduces the useful bandwidth.

Recently, multi-depth synchronized sources are being applied to suppress the ghosts. However, the signal response from multi-level sources and horizontal sources have a common zero notch frequency, which along with the bubble resonance prevent such multi-depth synchronized sources from improving the super low frequency response (e.g., 0-7 Hz), which is a band that is now attracting more interest on deep target detection.

Furthermore, the alternating actuation of the port and starboard side sub-arrays, which both produce the substantially the same signature, may not produce low frequency signals (e.g., below 50 Hz) with sufficient strength for acquiring seismic data on deeper and deeper portions of the subsurface.

Accordingly, it would be desirable to provide devices, systems and methods to boost low frequency signals. It would also be desirable to provide devices, systems, and methods to reduce the effect of ghost signals.

### SUMMARY

According to one embodiment, there is a method for boosting low frequency content of signals, which includes towing, by a vessel, a port side impulsive source array and a starboard side impulsive source array; and selectively actuating the port side and starboard side impulsive source arrays for a plurality of sequential shots having different signatures.

According to another embodiment there is a method for boosting low frequency content of signals and canceling ghost signals, which includes towing, by a vessel, a source array underwater, wherein the source array comprises a plurality of individual source elements, which include major, first auxiliary, and second auxiliary source elements; and serially actuating the major, first auxiliary, and second auxiliary source elements in time-delayed manner so that the first auxiliary source elements are actuated after the major source elements and the second auxiliary source elements are actuated after the first auxiliary source elements. An amplitude of a signal generated by the first auxiliary source elements is lower than an amplitude of a signal generated by the major source elements, and an amplitude of a signal generated by the second auxiliary source elements is lower than an amplitude of a signal generated by the first auxiliary source elements.

In another embodiment a delay between serially activating the major, first auxiliary, and second auxiliary source elements is based on a depth of the major, first auxiliary, and second auxiliary source elements and speed of sound. The major, first auxiliary, and second auxiliary source elements can be at a same depth and the delay is (2h*i)/c for the ith auxiliary source, wherein h is the depth and c is the speed of sound. The first and second auxiliary source elements can be at different depths and the delay is (hᵢ₋₁+hᵢ)/c, wherein hᵢ is the depth for the ith auxiliary source, c is the speed of sound, and h₀ is the depth of the major source.

In yet another embodiment the source array can include a plurality of laterally, spatially-separated sub-arrays, and the major, first auxiliary, and second auxiliary source elements are arranged in a same sub-array. Each of the sub-arrays can include the major, first auxiliary, and second auxiliary source elements.

In a further embodiment the source array can include a plurality of laterally, spatially-separated sub-arrays, and at least one of the major, first auxiliary, and second auxiliary source elements is arranged in a different ones of the sub-arrays from the other of the major, first auxiliary, and second auxiliary source elements. A first one of the sub-arrays can include a plurality of the major source elements and a second one of the sub-arrays includes a plurality of the first and second auxiliary source elements.

In another embodiment the source elements can be one of marine vibrator, air-gun, sparker, and explosive. If the source elements are air-guns, the major, first auxiliary, and second auxiliary source elements can have different volumes.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic survey system having a horizontal streamer;

FIG. 2 is a schematic diagram of a marine seismic survey system with three source sub-arrays;

FIG. 3 is a schematic diagram of port side and starboard side shots;

FIGS. 4A and 4B illustrate a sequence of shots where at least two of the shots have different signatures;

FIG. 5 is a flowchart of a method for boosting low frequency signals;

FIG. 6 is a graph illustrating the spectrum difference for a desynchronized shot and a port side shot;

FIGS. 7A and 7B are graphs illustrating the responses from a horizontal source and a three-level source;

FIGS. 8A and 8B are schematic diagrams illustrating the cancellation of ghosts using shots having the same amplitude;

FIGS. 9A and 9B are schematic diagrams illustrating the cancellation of ghosts using shots having a decreasing amplitude;

FIG. 10 is a flowchart of a method for boosting low frequency signals by canceling ghosts;

FIGS. 11A-11C are graphs illustrating responses from a conventional horizontal source and sources using ghost cancellation;

FIGS. 12A and 12B are schematic diagrams of source array firing configurations; and

FIG. 13 is a schematic diagram of a control system.

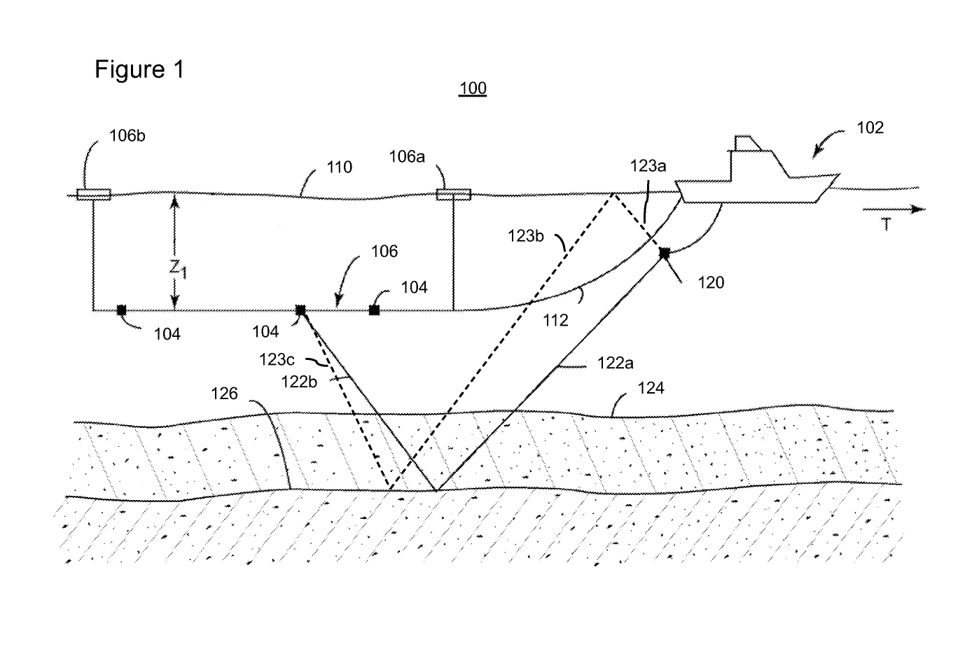

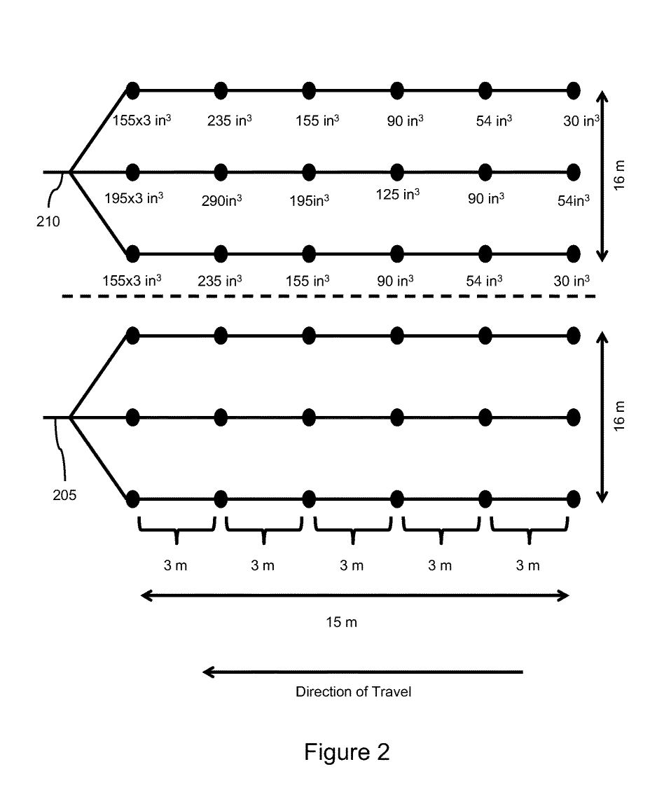

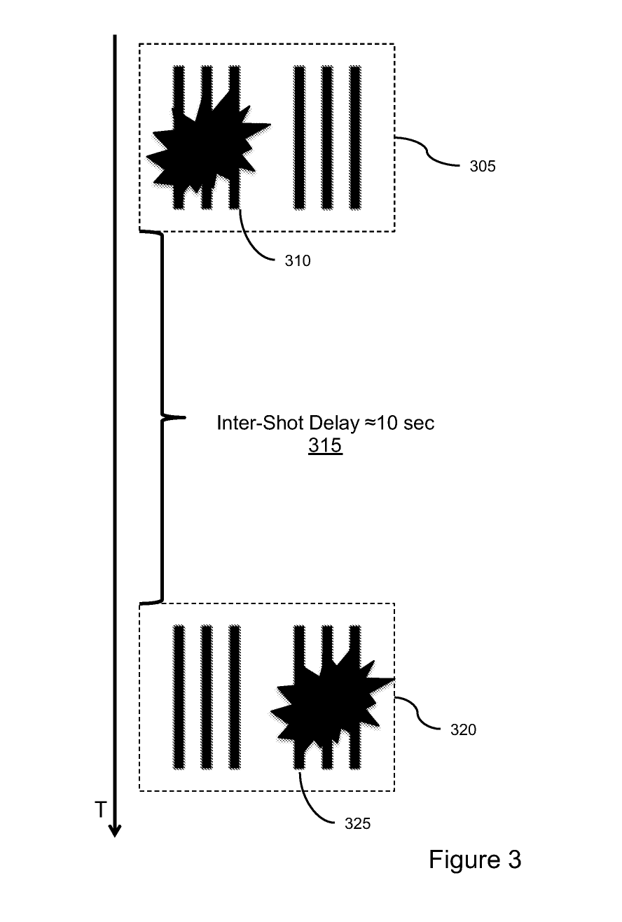

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to the terminology and structure of marine seismic surveys. However, the embodiments to be discussed next are not limited to marine seismic surveys, but may be applied to other types of surveys in which boosted low frequencies and/or ghost signal cancellation is desired.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It has been recognized that the results of a survey can be improved by varying the signatures from one shot to another. Specifically, it has been found that low frequency content of the acquired data can be enhanced by actuating the port and starboard side source arrays simultaneously or in a time-delayed manner, and that one or more of these shots can be used in a survey with port and/or starboard side impulsive source array shots.

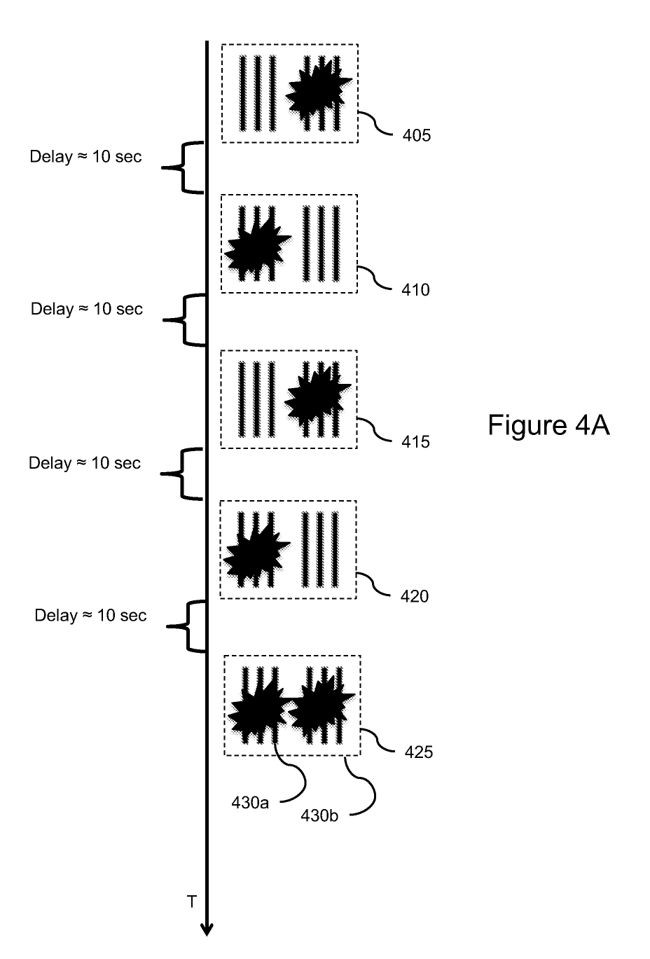

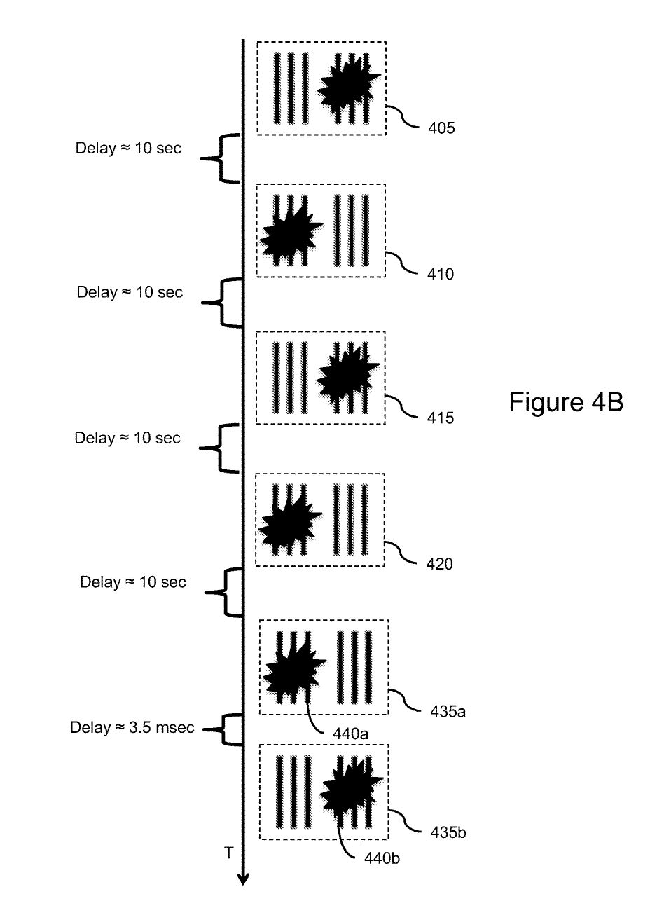

Accordingly, impulsive source arrays are selectively actuated for a plurality of sequential shots, at least two of which have a different signature. FIGS. 4A and 4B illustrate two shot sequences where at least two shots have different signatures. Both shot sequences involve a series of alternating starboard side shots (405 and 415) and port side shots (410 and 420), which have substantially the same signature, along with a synchronized shot 425 (FIG. 4A) or desynchronized shot 435 (FIG. 4B), both of which have a different signature than the starboard side and port side shots. FIG. 4A illustrates a synchronized shot 425, which boosts low frequencies by simultaneously actuating the port side impulsive source array 430a and the starboard side impulsive source array 430b. This simultaneous actuation can boost the content of frequencies below 50 Hz by 6 dB.

FIG. 4B schematically illustrates a desynchronized shot 435, which boost low frequencies and can further exclude middle frequencies (50-100 Hz) and high frequencies (>100 Hz). This shot, which can also be referred to as a dithered shot, desynchronizes the signals produced by port side and starboard side source arrays by introducing a delay between actuation. In FIG. 4B the port side impulsive source array 440a is actuated first and then after a short delay on the order of milliseconds (3.5 ms in the illustrated example) the starboard side impulsive source array 4400b is actuated. In contrast to the delay used in the starboard shots 405 and 415 and the port side shots 410 and 420, which is designed to be long enough so that there is little or no interference between the two shots on a seismic sensor, the delay in between actuation of the port side array 440a and the starboard side array 440b is designed to be long enough so that the actuation of the port and starboard side impulsive source arrays are not synchronized like shot 425 in FIG. 4A but short enough so that the reflections caused by the actuations are part of the same reception window by a seismic sensor. The shot 425 of FIG. 4A produces a different signature than the shot 435 of FIG. 4B, both of which have different signatures than the starboard side shots 405 and 415 and the port side shots 410 and 420.

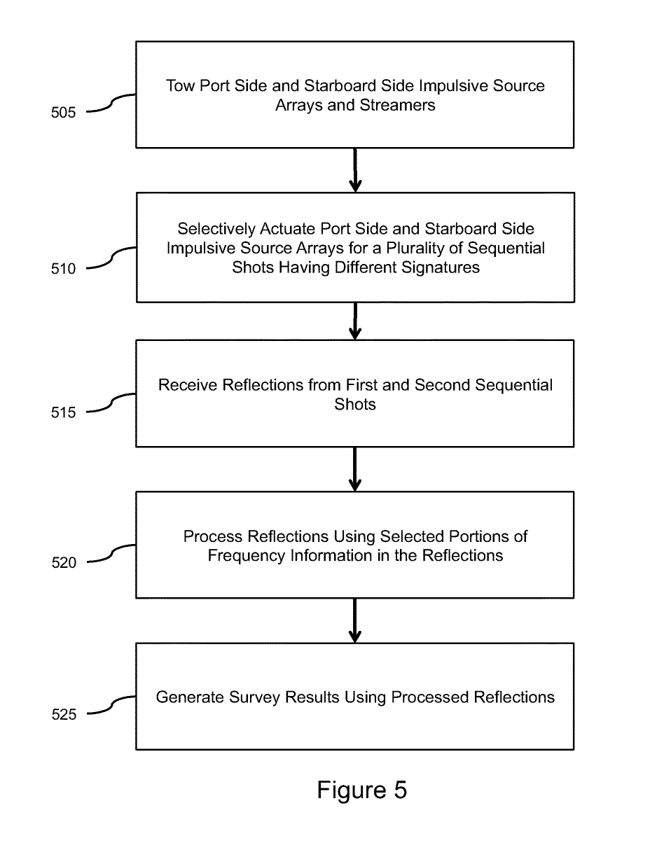

FIG. 5 is a flowchart of a method for boosting low frequency signals. Initially, a vessel tows a port side and starboard side impulsive source arrays, as well as streamers (step 505). The port side and starboard side source arrays are then selectively actuated for a plurality of sequential shots having different signatures from shot-to-shot (step 510). A first one of the plurality of sequential shots involves simultaneous actuation of the port side and starboard side impulsive source arrays (as illustrated in FIG. 4A) or a time-delayed actuation of the port side and starboard side impulsive source arrays (as illustrated in FIG. 4B). A second one of the plurality of sequential shots involves actuation of the port side impulsive source array or actuation of the starboard side impulsive source array. It should be recognized that unless otherwise specified the reference to a first and second one of the plurality of shots does not imply that these shots are performed in numerical order but instead that these are different shot, i.e., actuations of the impulsive source arrays.

The streamers receive reflections from the first and second sequential shots (step 515) and a marine survey processor processes the reflections using selected portions of the frequency information in the reflections (step 520). For example, the reflections resulting from the simultaneous and time-delayed actuations illustrated in FIGS. 4A and 4B can be processed to remove the high frequency information and maintain the middle and low frequency information. The reflections from one of the port side or starboard side shots can be processed using selected portions of the frequency to remove the low frequency information and maintain the middle and high frequency information. By using the different signatures of the first and second shots, these shots can then be processed using similar or different processing techniques. Specifically, the simultaneous or desynchronized shots can be processed using full waveform inversion or tomography for velocity model building and the model can then be used as an initial model for reverse time migration using the port side and/or starboard side shot. The information produced by processing the reflections can then be used by the marine seismic processor to generate survey results (step 525).

It should also be recognized that although the steps in FIG. 5 are illustrated in a serial order, these steps could be performed in parallel. Thus, the vessel will tow impulsive source arrays and streamers while one or more of steps 510-525 are performed.

Although the method of FIG. 5 was described generally using two shots as part of the plurality of sequential shots having different signatures. It should be recognized that the plurality includes at least two but can also include more than two, which is described above in connection with FIGS. 4A and 4B. The sequence can be geology dependent or independent, such as doing a synchronized or desynchronized shot in areas having structures that are of particular interest, and the pace of the shots can be variable.

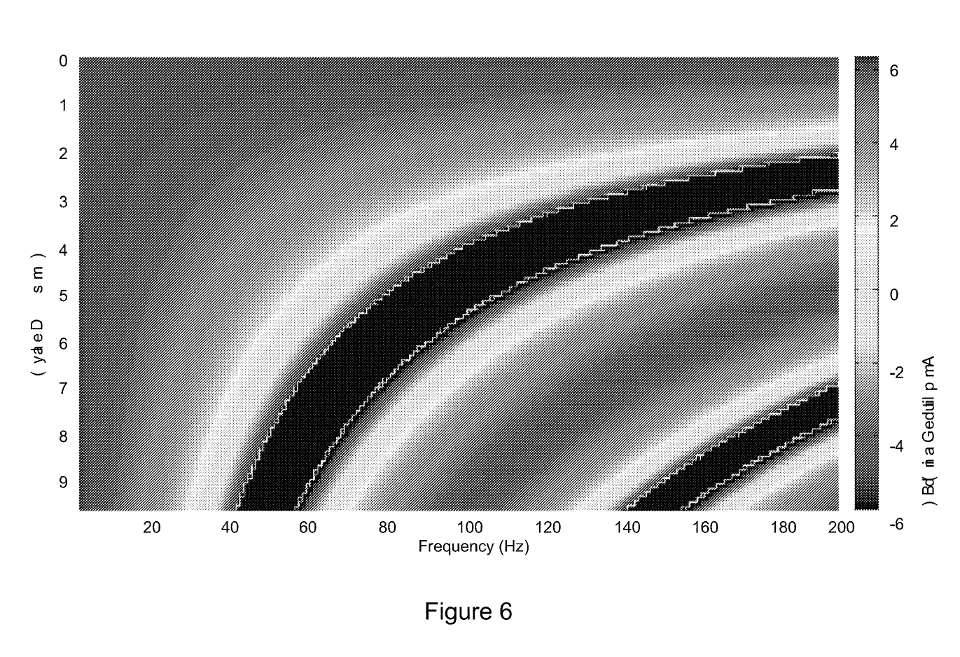

FIG. 6 is a graph illustrating a simulation of the spectrum difference for a desynchronized shot and a port side source shot as a function of delay between actuation of the starboard and port sources. In FIG. 6 the two dark bands between the jagged white lines (i.e., the bands starting between approximately 40 and 60 Hz and between approximately 140 and 160 Hz on the X axis) have an amplitude gain of approximately −6 dB, which increases towards +6 dB moving away from these bands. As will be appreciated from this graph, a desynchronized shot with a 3.5 ms delay between actuation of the starboard and port side source arrays produces a boost of 6 dB at frequencies less than 20 Hz, maintains the amplitudes of the middle frequencies (i.e., 50-100 Hz), while diminishing the amplitudes of the high frequencies (100-180 Hz).

The particular delay between actuation of the starboard and port side source arrays can be used to set the splitting points for the low, medium, and high frequencies, which can be adjusted depending upon the depth of the target. Using the notational signature of all of the guns in the sources the pressure field can be calculated using Ziolkowski's model. For more information about Ziolkowski's model the interested reader should refer to “The Signature of an Air-Gun Array-Computation from Near-Field Measurements Including Interactions” by Ziolkowski et al. Geophysics 47, 1412-1421, the entire disclosure of which is expressly incorporated by reference herein. For a deep target (e.g., greater than 100 m) the splitting point between low and medium frequencies may, for example, be at 15 Hz and the splitting point between medium and high frequencies may, for example, be at 50 Hz. For a shallow target (e.g., up to 100 m) the splitting point between low and medium frequencies may, for example, be at 25 Hz and between medium and high frequencies may, for example, be at 150 Hz. Using this information the graph in FIG. 6 can be employed to determine the desired delay between actuation of the port and starboard source arrays for a desynchronized shot.

In the discussion above the synchronized and desynchronized shots have been generally described as involving actuation of the port and starboard impulsive source arrays. This can involve actuation of all of the impulsive sources in these arrays. Alternatively, this can involve actuation of less than all of the impulsive sources in either or both arrays. The decision of whether to actuate all or less than all impulsive sources in either or both arrays can be predefined and constant or variable according to geology and/or mechanical constraints.

The use of a subset of impulsive sources within the arrays can involve using all impulsive sources having a volume larger than a certain size (e.g., >100 in³), including spare impulsive sources, which would maximize the low-frequency output.

In another embodiment the simultaneous and/or desynchronized shots can use impulsive sources that are not used in either a regular port or starboard side shot, which also further increases the low-frequency output. This embodiment can also be implemented in a mono-source type of survey in which extra impulsive source(s), in the existing sub-array or on separate sub-arrays, are fired with the mono-source to form the synchronized or desynchronized shots, which increases the low frequency energy compared to the mono source itself.

In yet another embodiment, the synchronized or desynchronized shot involves firing the port and/or starboard side sources with minor variations, such as lower gun refilling pressure. This embodiment can be employed when very big impulsive sources (e.g., 380 in³ impulsive sources) are used in the port and/or starboard side arrays and when firing the impulsive sources in a rapid pace prevents the big impulsive sources from fully recharging.

The embodiment discussed above involves boosting the low frequency content of acquired data by selectively actuating impulsive sources (i.e., air-guns) of source arrays for a plurality of sequential shots, at least two of which have a different signature. An embodiment will now be described in which the low frequency content of acquired data is enhanced while also canceling ghosts. In the embodiment that follows the source elements can be air-guns, a marine vibrator, a sparker, explosives or any other energy-source that is deployed in a marine setting.

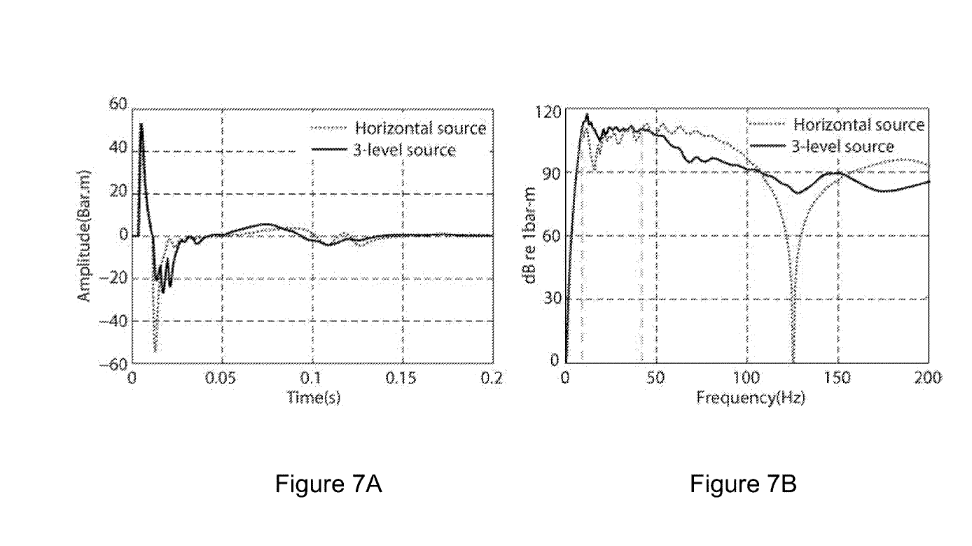

As discussed above, ghosts caused by surface reflections can negatively impact the ability to depict the desired subsurface and that multi-level sources have been attempted to address this problem. FIGS. 7A and 7B illustrate the response for a horizontal source located 6 m below the water's surface and a desynchronized three-level source (the sources being located at 6 m, 9 m, and 12 m below the water's surface), which illustrates a common zero notch frequency, and thus multi-level sources by themselves do not address this problem. Further, multi-level sources are difficult to implement.

For an n-element marine source, the expression of its far-field signature underneath the source can be represented as:

$$\begin{matrix}{P}_{far} ( t ) = {\sum }_{i = 1}^{n} {P}_{p\_i} ( t - Δ {T}_{i} - Δ {t}_{i} ) + {RP}_{p\_i} ( t - Δ {T}_{i} - Δ {t}_{i} - Δ {τ}_{i} ) & ( 2 ) \\ Δ {τ}_{i} = 2 {h}_{i} / c & ( 3 )\end{matrix}$$

where P_{far} is the far-field signature, which is the superposition of primaries Pₚ_{_}ᵢ and ghosts, which are represented by RPₚ_{_}ᵢ where R is the reflection coefficient at sea surface (−1 is usually given). ΔTᵢ is the firing time difference between the first source and the remaining ones, which is usually given in a synchronized multi-level source to align the primaries to the same phase. Δtᵢ is the travelling time difference for each source to the far-field, which depends on the distance between the element and the defined far-field. The existence of ΔTᵢ and Δtᵢ promise the in-phase superposition at far-field for a generalized multi-depth source. Δτᵢ is the time delay for ghosts corresponding to their own primaries.

ΔTᵢ and Δtᵢ are both zero for a conventional horizontal source. Therefore, the ghosts will be constructive because of the single depth. As will be appreciated from equation (1), the primary signal and its corresponding ghost have the same waveform despite being of opposite polarity.

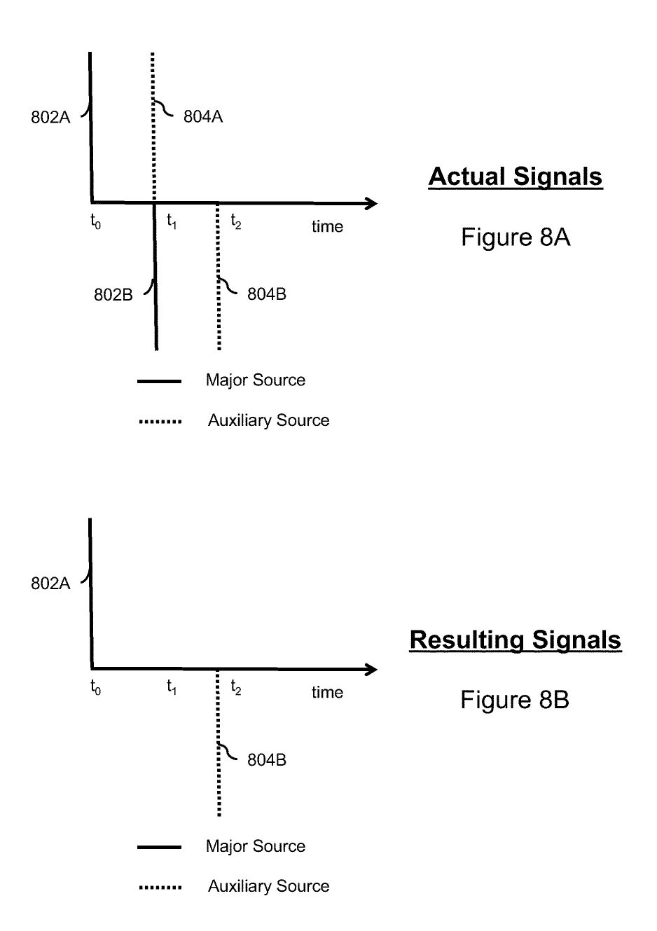

In accordance with an embodiment ghost cancelation is achieved by serially actuating a plurality of sources in a time-delayed manner. In the discussion that follows the serial actuation involves actuation of a major source followed by one or more auxiliary sources. The terms major source and auxiliary source are used for ease of reference to distinguish how these sources are used to cancel ghosts and boost low frequency signal response. The major and auxiliary sources can be the same or different types of sources. The FIGS. 8A and 8B are schematic diagrams illustrating the cancellation of ghosts using shots having the same amplitude.

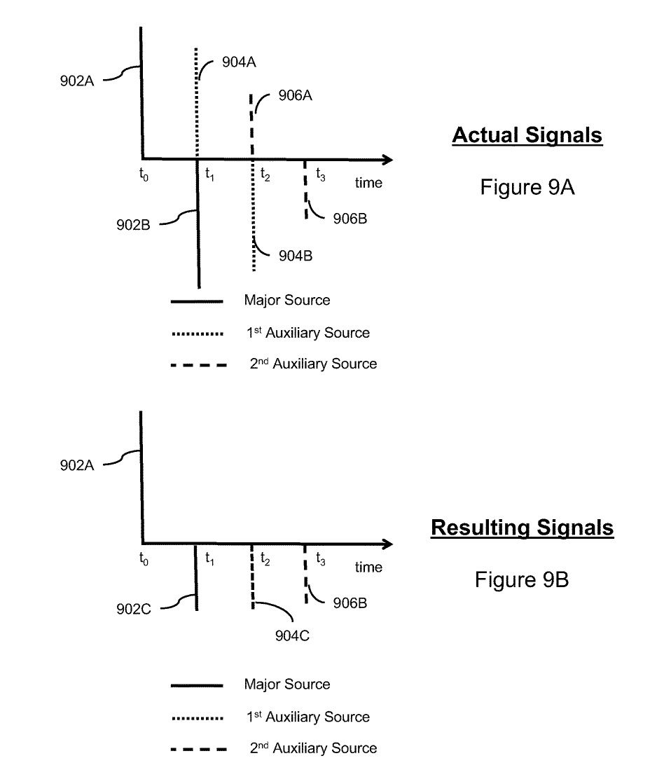

A major source is actuated at time t₀ to produce signal 802A and then an auxiliary source is actuated after a delay at time t₁ to produce signal 804A. The delay can be 2h/c, where h is the depth of the source and c is the speed of sound. Actuation of the major source also produces a ghost signal 802B at time t₁ and actuation of the auxiliary source also produces a ghost signal 804B at time t₂. As illustrated in FIG. 9A, the amplitude of the signal 802A produced by the major source and the amplitude of the signal 804A produced by the auxiliary source are the same and accordingly the ghost signals 802B and 804B will likewise have the same amplitude. As illustrated in FIG. 9B, at time t₁ the signal 804A produced by actuation of the auxiliary source cancels the ghost signal 802B produced by actuation of the major source but also results in a large, double time delayed ghost signal 804B at time t₂ due to actuation of the auxiliary source. This secondary ghost signal 804B makes it appear that the major source is fired at a position with double depth. Thus, this source actuation sequence time shifts but does not diminish the ghosts.

FIGS. 9A and 9B are schematic diagrams of a sequential source actuation sequence that reduces the overall effect of ghosts. As illustrated in FIG. 9A, the sequential actuation of the major, first auxiliary, and second auxiliary sources involve actuating these sources with decreasing amplitude. Specifically, actuation of the major source produces signal 902A and ghost signal 902B, which have a larger amplitude than the signal 904A and ghost signal 904B produced by actuation of the first auxiliary source. Similarly, actuation of the second auxiliary source produces a signal 906A and ghost signal 906B having a smaller amplitude than signal 904A and ghost signal 904B produced by actuation of the first auxiliary source. As can be seen by comparing FIGS. 9A and 9B, the reduced amplitude actuation of the first auxiliary source reduces but does not eliminate the ghost from the major source so as to produce ghost signal 902C at time t₂ and the reduced amplitude signal 906A produced by actuation of the second auxiliary source reduces but does not eliminate the ghost of the first auxiliary source so as to produce ghost signal 906B at time t₃. This actuation sequence can be implemented so that the first auxiliary source has a peak that is ⅔ of the major source and the second auxiliary source is ⅓ as strong as the major source. Thus, as illustrated in FIG. 9B, the final signature smears the ghost and comparatively suppresses the ghosts due to the non-in-phase superposition.

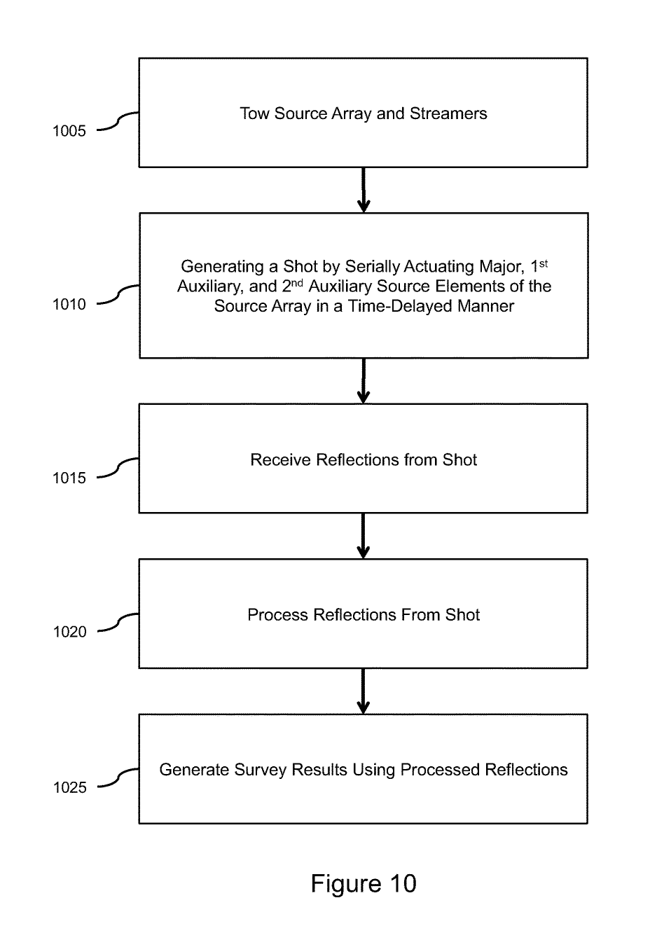

FIG. 10 is a flow chart for boosting low frequency signals by canceling ghosts. While a vessel tows the source array and streamers (step 1005) a shot is generated by serially actuating major, first auxiliary, and second auxiliary source elements in a source array in a time-delay manner (step 1010). The reflections from the shot are received by the streamers (step 1015) and a marine survey processor processes the reflections (step 1020) in order to generate the survey results (step 1025).

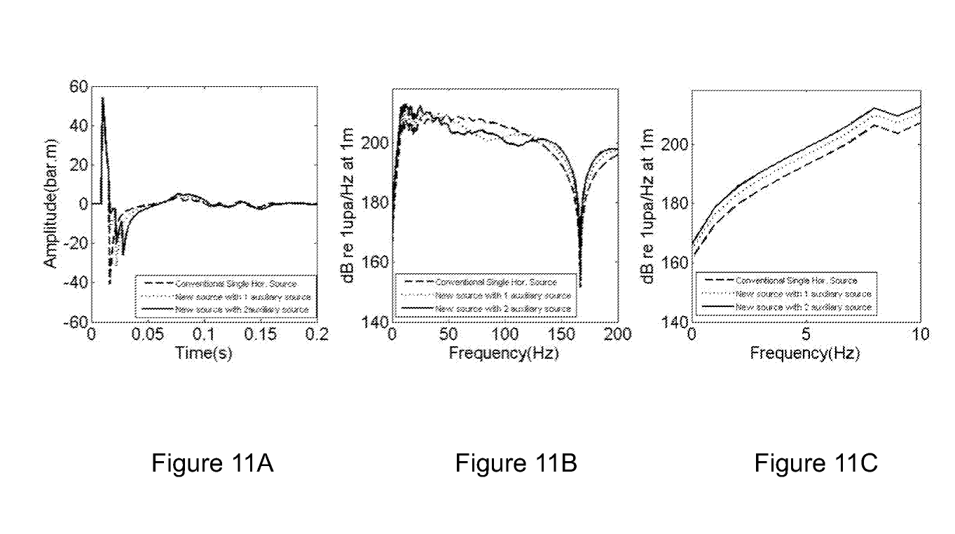

FIGS. 11A-110 illustrate comparisons, based on a Johnson model, of simulations for a conventional horizontal source and a horizontal source with serially actuated sources. For more information regarding the Johnson model the interested reader should refer to “Understanding Air-Gun Bubble Behavior” by D. T. Johnson Geophysics 59, 1729-1734 (1994), the entire disclosure of which is expressly incorporated by reference herein. The first source is a 3-sub-array combined horizontal source and each sub-array is 680 in³ (250 in³, 150 in³, 100 in³, 80 in³, 60 in³, and 40 in³). As will be appreciated by comparing the signatures using one, two, and three sources, using two or more horizontal sources that are serially actuated with a delay and amplitude as described above improves the frequency response both at low and high bands. As highlighted by the frequency range in FIG. 110, at low frequencies that may be beneficial for deep target exploration the improvement is 5 dB.

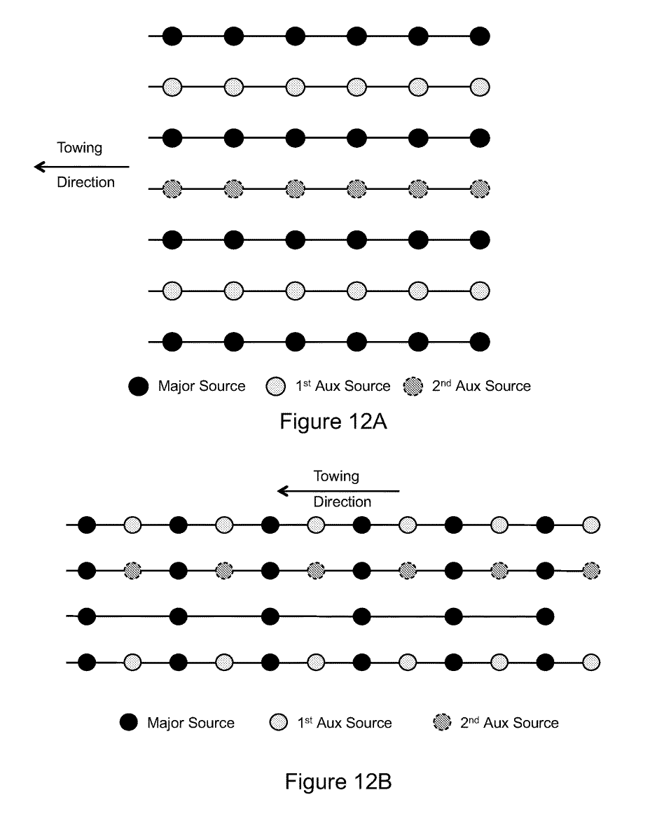

The discussion above generally refers to actuating the major, first auxiliary, and second auxiliary sources, which can be implemented in a number of ways, two of which are illustrated in FIGS. 12A and 12B. FIG. 12A illustrates an inline arrangement where there are four horizontal sub-arrays for the major source along the towing direction, two horizontal sub-arrays for the first auxiliary source along the towing direction, and one sub-array for the second auxiliary source along the towing direction. FIG. 12B illustrates an inline arrangement in which there are four sub-arrays and the first and second auxiliary sources are arranged along the same sub-arrays in the direction of the survey as the major source. Other arrangements of the major, first auxiliary, and second auxiliary sources are possible.

The optimal choice of the first and second auxiliary sources depends on the number of elements in the major source and how many of the first and second auxiliary sources are used. To uniformly divide the ghosts, the first and second auxiliary sources may be simply designed with a least square error function:

$$E = {( M - {A}_{1} )}^{2} + {A}_{n}^{2} + {\sum }_{i = 1}^{n - 1} {( {A}_{i} - {A}_{i + 1} )}^{2} \qquad ( 4 )$$

In which M is the number of sub-arrays of the major source, n is the number of first and second auxiliary sources, and Aᵢ is the number of sub-arrays of the ith first and second auxiliary sources.

When the first and second auxiliary sources are deployed at the same depth as the major source, the firing time delay for each first auxiliary and second auxiliary source is the same (ΔT=(2h*i)/c), which means that the cancellation of ghosts occurs at the same depth.

Although an embodiment has been described with the first and second auxiliary sources deployed at the same depth as the major source, this need not be the case. The first and second auxiliary sources can be deployed at different depths, in which case the depths of its own and its former source determine the firing time delay. For the ith auxiliary source, the delay is ΔT=(hᵢ₋₁+hᵢ)/c, where for the first auxiliary source h₀ is the depth of the major source.

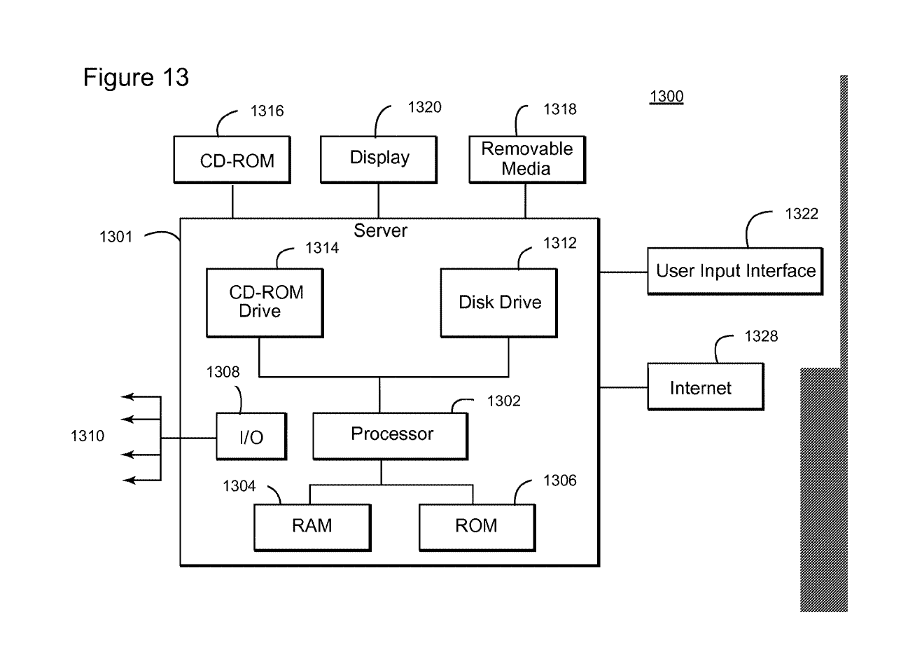

An example of a representative control system capable of carrying out operations in accordance with the exemplary embodiments discussed above is illustrated in FIG. 13. Hardware, firmware, software or a combination thereof may be used to perform the various steps and operations described herein.

The exemplary control system 1300 suitable for performing the activities described in the above-noted embodiments may include server 1301. Such a server 1301 may include a central processor unit (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Processor 1302 may communicate with other internal and external components through input/output (I/O) circuitry 1308 and bussing 1310, to provide control signals and the like. For example, processor 1302 may communicate with the sensors, electro-magnetic actuator system and/or the pressure mechanism of the source element. Processor 1302 carries out a variety of functions as are known in the art, as dictated by software and/or firmware instructions.

Server 1301 may also include one or more data storage devices, including hard and disk drives 1312, CD-ROM drives 1314, and other hardware capable of reading and/or storing information, such as a DVD, etc. In one embodiment, software for carrying out the above-discussed steps may be stored and distributed on a CD-ROM 1316, removable media 1318 or other form of media capable of portably storing information. These storage media may be inserted into, and read by, devices such as the CD-ROM drive 1314, the disk drive 1312, etc. Server 1301 may be coupled to a display 1320, which may be any type of known display or presentation screen, such as LCD, plasma displays, cathode ray tubes (CRT), etc. A user input interface 1322 is provided, including one or more user interface mechanisms such as a mouse, keyboard, microphone, touch pad, touch screen, voice-recognition system, etc.

Server 1301 may be coupled to other computing devices, such as the equipment of a vessel, via a network. The server may be part of a larger network configuration as in a global area network (GAN) such as the Internet 1328, which allows ultimate connection to the various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

Both of the disclosed embodiments provide systems and methods for boosting low frequency response during a seismic survey, and one of the embodiments also cancels ghosts. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for boosting low frequency content of signals, comprising:
towing, by a vessel, a port side impulsive source array and a starboard side impulsive source array;
selectively actuating the port side and starboard side impulsive source arrays for a plurality of sequential shots having different signatures.

2. The method of claim 1, wherein
a first one of the plurality of sequential shots involves
simultaneous actuation of the port side and starboard side impulsive source arrays; or
a time-delayed actuation of the port side and starboard side impulsive source arrays; and
a second one of the plurality of sequential shots involves
actuation of the port side impulsive source array; or
actuation of the starboard side impulsive source array.

3. The method of claim 2, further comprising:
receiving, by at least one hydrophone, reflections from the first and second ones of the plurality of sequential shots;
processing the reflection from the first one of the plurality of sequential shots by removing a first set of frequencies and maintaining frequencies below the first set of frequencies; and
processing the reflection from the second one of the plurality of sequential shots by removing a second set of frequencies and maintaining frequencies above the first set of frequencies.

4. The method of claim 2, wherein actuation of the port side or starboard side impulsive source arrays in the first or second shots involves actuation of one or more, but less than all, sub-arrays of the port side or starboard side impulsive source arrays.

5. The method of claim 4, wherein, based on geology or mechanical constraints, a number of the sub-arrays actuated for the first or second shot is predefined and constant or is variable.

6. The method of claim 4, wherein the sub-arrays actuated for the first shot include only air-guns above a predetermined volume threshold.

7. The method of claim 4, wherein the sub-arrays actuated for the first shot include at least one sub-array that is not actuated for the second shot.

8. The method of claim 1, wherein when the port side or starboard side impulsive source array is actuated, the impulsive sources of the array have a lower refilling pressure than when the impulsive sources of the arrays are actuated for the first shot.

9. The method of claim 1, wherein
each one of the port side and starboard side impulsive source arrays includes a set of major source elements and a set of auxiliary source elements,
one of the plurality of sequential shots comprises actuation of one of the sets of major source elements and one of the sets of auxiliary source elements,
the set of auxiliary source elements is actuated after the set of major source elements, and
an amplitude of a signal produced by the set of auxiliary source elements is smaller than an amplitude of a signal produced by the set of major source elements.

10. The method of claim 1, wherein
each one of the port side and starboard side impulsive source arrays includes a set of major source elements, a set of first auxiliary source elements, and a set of second auxiliary source elements,
one of the plurality of sequential shots comprises actuation of one of the sets of major source elements, one of the sets of the set of first auxiliary source elements, and one of the sets of second auxiliary source elements,
the set of first auxiliary source elements is actuated after the set of major source elements and the set of second auxiliary source elements is actuated after the set of first auxiliary source elements, and
an amplitude of a signal produced by the set of first auxiliary source elements is smaller than an amplitude of a signal produced by the set of major source elements and an amplitude of a signal produced by the set of second auxiliary source elements is smaller than the amplitude of the signal produced by the set of first auxiliary source elements.

11. A system for boosting low frequency content of signals, comprising:
a vessel;
a port side impulsive source array and a starboard side impulsive source array, which are attached to and towed by the vessel; and
a source array actuation controller configured to selectively actuating the port side and starboard side impulsive source arrays for a plurality of sequential shots having different signatures.

12. The system of claim 11, wherein
a first one of the plurality of sequential shots involves
simultaneous actuation of the port side and starboard side impulsive source arrays; or
a time-delayed actuation of the port side and starboard side impulsive source arrays; and
a second one of the plurality of sequential shots involves
actuation of the port side impulsive source array; or
actuation of the starboard side impulsive source array.

13. The system of claim 12, further comprising:
at least one hydrophone coupled to the vessel and configured to receive reflections from the first and second ones of the plurality of sequential shots;
a marine survey processor configured to
process the reflection from the first one of the plurality of sequential shots by removing a first set of frequencies and maintaining frequencies below the first set of frequencies; and
process the reflection from the second one of the plurality of sequential shots by removing a second set of frequencies and maintaining frequencies above the second set of frequencies.

14. The system of claim 12, wherein actuation of the port side or starboard side impulsive source arrays in the first or second shots involves actuation of one or more, but less than all, sub-arrays of the port side or starboard side impulsive source arrays.

15. The system of claim 14, wherein, based on geology or mechanical constraints, a number of the sub-arrays actuated for the first or second shot is predefined and constant or is variable.

16. The system of claim 14, wherein the sub-arrays actuated for the first shot include only air-guns above a predetermined volume threshold.

17. The system of claim 14, wherein the sub-arrays actuated for the first shot include at least one sub-array that is not actuated for the second shot.

18. The system of claim 12, wherein when the port side or starboard side impulsive source array is actuated, the impulsive sources of the array have a lower refilling pressure than when the impulsive sources of the arrays are actuated for the first shot.

19. The system of claim 11, wherein
each one of the port side and starboard side impulsive source arrays includes a set of major source elements and a set of auxiliary source elements,
one of the plurality of sequential shots comprises actuation of one of the sets of major source elements and one of the sets of auxiliary source elements,
the set of auxiliary source elements is actuated after the set of major source elements, and
an amplitude of a signal produced by the set of auxiliary source elements is smaller than an amplitude of a signal produced by the set of major source elements.

20. The system of claim 11, wherein
each one of the port side and starboard side impulsive source arrays includes a set of major source elements, a set of first auxiliary source elements, and a set of second auxiliary source elements,
one of the plurality of sequential shots comprises actuation of one of the sets of major source elements, one of the sets of the set of first auxiliary source elements, and one of the sets of second auxiliary source elements,
the set of first auxiliary source elements is actuated after the set of major source elements and the set of second auxiliary source elements is actuated after the set of first auxiliary source elements, and
an amplitude of a signal produced by the set of first auxiliary source elements is smaller than an amplitude of a signal produced by the set of major source elements and an amplitude of a signal produced by the set of second auxiliary source elements is smaller than the amplitude of the signal produced by the set of first auxiliary source elements.
